(19) United States
(12) Patent Application Publication
(10) Pub. No.: US 2014/0212752 A1
(43) Pub. Date: Jul. 31, 2014

(54) NONAQUEOUS ELECTROLYTE SECONDARY BATTERY

(71) Applicants: Masayasu Arakawa, Taito-ku Tokyo (JP); Tomonobu Tsujikawa, Minato-ku Tokyo (JP); Yoshiki Miyamoto, Chuo-ku Tokyo (JP); Koji Hayashi, Chuo-ku Tokyo (JP)

(72) Inventors: Masayasu Arakawa, Taito-ku Tokyo (JP); Tomonobu Tsujikawa, Minato-ku Tokyo (JP); Yoshiki Miyamoto, Chuo-ku Tokyo (JP); Koji Hayashi, Chuo-ku Tokyo (JP)

(21) Appl. No.: 14/241,933

(22) PCT Filed: Sep. 3, 2012
(86) PCT No.: PCT/JP2012/072321

§ 371 Date: Feb. 28, 2014

(30) Foreign Application Priority Data
Sep. 2, 2011 (JP) 2011-192037

(51) Int. Cl. H01M 4/62

(52) U.S. Cl. CPC H01M 4/628
USPC 429/212

(57) ABSTRACT

A non-aqueous electrolyte secondary battery capable of improving a high rate discharge property while securing safety is provided. A laminated electrode group 10 is sealed in a laminate film of an outer casing in a lithium-ion secondary battery. A positive electrode plate 14 and a negative electrode plate 15 are stacked alternatively in the laminated electrode group 10. In the positive electrode plate 14, a positive electrode mixture layer W2 containing a lithium manganese complex oxide of a positive electrode active material is formed at both surfaces of an aluminum foil W1. In the positive electrode mixture layer W2, other than the positive electrode active material, a carbon material of a conductor and a phosphazene compound of a flame retardant are dispersed and mixed uniformly. A ratio of a mass of the conductor to that of the flame retardant is set to 1.3 or more. In the negative electrode plate 15, a negative electrode mixture layer containing a negative electrode active material is formed at both surfaces of a rolled copper foil. Electron conductivity in the positive electrode plate 14 is secured by the conductor.

### FIELD OF THE INVENTION

The present invention relates to a non-aqueous electrolyte secondary battery, and more particularly to a non-aqueous electrolyte secondary battery of which design capacity is 5 Ah or more, comprising: a positive electrode plate having a positive electrode mixture layer; and a negative electrode plate having a negative electrode mixture layer in which a negative electrode active material is included.

### DESCRIPTION OF RELATED ART

Because a non-aqueous electrolyte secondary battery represented by a lithium-ion secondary battery has a high voltage and a high energy density and is excellent in storage performance and low temperature operation performance, it is being widely used in mobile-type electronic products for civilian use. Further, the non-aqueous electrolyte secondary battery is used not only as a miniature power source for mobile use, but it is also being developed as a power source for an electric vehicle and a nighttime power storage facility for home use, and further developed as an industrial power source for utilizing nature energy such as sunshine, wind force or the like efficiently, leveling in use of electric power, uninterruptible power supply apparatuses (UPS) and construction equipments. In other words, the power source for mobile use has a capacity of several Ah, whereas the power source for an electric vehicle is required to have the capacity of about 10 Ah, and the power source for operating industrial equipment, for communication backup, or for storing the power generated by a generation apparatus due to sunshine or wind force is required to have the capacity of from dozens of Ah to 100 Ah or more. Thus, the battery turns toward a large capacity.

While, there is a high rate discharge property, namely, a discharge capacity at a large current, as one of important properties among battery properties. Because, in general, when the battery is discharged at a large current, a voltage drop becomes larger comparing when the battery is discharged at a small current, the capacity at the time of discharging at a large current becomes smaller than that discharging at a small current. Such a high rate discharge property varies a degree of requirement depending upon battery use. For example, among emergency power sources, such a degree of requirement is low in use for a radio base station of mobile phones, but in use for UPS, the high rate discharge property is one of important performance.

Further, in general, because organic compounds contained in an electrolyte of the non-aqueous electrolyte secondary battery is inflammable, under abnormal high temperature circumstances such as heat generation at the time of short circuit, there is a case that the electrolyte burns, which brings about a problem of safety. Further, when a battery temperature is going up, especially when the battery is in a charging situation, because a chemical compound used for a positive electrode releases oxygen to decompose, burning is accelerated. A situation that a battery temperature increases due to burning and a burning reaction is further accelerated is sometimes called as a thermal runaway situation. Under this thermal runaway situation, fumes appearing from the battery are observed continuously. If the situation becomes more violent, the battery may catch fire and a batter container may be damaged due to a rapid increase in internal pressure. On the other hand, when a battery is large-sized, a calorific value becomes large as stated above, whereas a surface area of the battery does not become large comparatively. Because heat release from a battery is in proportion to a surface area thereof, if a battery capacity becomes large, a heat release speed becomes slow and thereby heat reserve within the battery becomes large inevitably. As a result of it, since a temperature-rise speed of a battery increases with large-sizing thereof, a large-sized battery appears a safety problem unlike a small power source for mobile use. In other words, even if safety is confirmed by an overcharge test, nailing test and the like in a small-sized battery for mobile use, in a case that the same tests were carried out for a large-sized battery manufactured entirely with the same materials, it may cause a serious problem in safety, which is different in quality such as catching fire or bursting.

Various safety technologies have been proposed to secure safety of a battery. For example, in order to control burning of a non-aqueous electrolyte, a number of documents disclose a technology of adding a flame retardant (nonflammability giving material) to the non-aqueous electrolyte. (See, e.g., JPA 2006-286571.) Further, Applicants have disclosed a technology for mixing a solid (body) flame retardant into the mixtures of positive and negative electrodes. (See JPA 2009-016106.)

### SUMMARY OF THE INVENTION

### Problem to be Solved by the Invention

The technology of JPA 2006-286571 is a technology for flameproofing (fireproofing) a non-aqueous electrolyte in which a flame retardant is contained. With an amount of the flame retardant to be contained, it is possible to make the non-aqueous electrolyte flameproof (fireproof). In general, if a flame retardant is added to a non-aqueous electrolyte, ionic conductivity in the non-aqueous electrolyte becomes insufficient to lower an output and a high rate discharge property. On the other hand, the technology of JPA 2009-016106 also improves safety of a battery by mixing the flame retardant into the mixtures of positive and negative electrodes, but there is a possibility of bringing about lowering of the high rate discharge property. While, as stated above, safety of a battery is apt to be lowered with large sizing of the battery. In order to control this, it is necessary to increase a mixing amount of the flame retardant. Consequently, there is a problem in that the high rate discharge property becomes more lowered. Accordingly, non-aqueous electrolyte batteries may be used in many ways and spread if safety of the battery is not only secured but also lowering of the high rate discharge property is controlled.

Inventors made an elaborate study on a mechanism which lowers the high rate discharge property in a case that the flame retardant is mixed to the mixtures of positive and negative electrodes. As a result of it, Inventors found that the main causes of lowering of the high rate discharge property lie in that electron conductivity at the positive electrode is impeded and in lowering of electron conductivity at the positive and negative electrodes, by mixing the flame retardant having insulation performance inherently to the positive and negative electrodes.

In view of the above circumstances, an object of the present invention is to provide a non-aqueous electrolyte secondary battery capable of improving a high rate discharge property while securing safety thereof.

### Means for Solving the Problem

In order to achieve the above object, the present invention is directed to a non-aqueous electrolyte secondary battery of which design capacity is 5 Ah or more, comprising: a positive electrode plate having a positive electrode mixture layer; and a negative electrode plate having a negative electrode mixture layer in which a negative electrode active material is included, wherein the positive electrode mixture layer includes a positive electrode active material, a flame retardant, a conductor and a binder, and is formed in a manner that these are dispersed and mixed, wherein a ratio of a mass of the conductor to that of the flame retardant is 1.3 or more.

In the present invention, the positive electrode mixture layer may be formed in a manner that the flame retardant is dispersed and mixed in a range of from 2.5 mass % to 7.5 mass % to the positive electrode active material. At this time, it is preferable that pores are formed at the positive electrode mixture layer, and wherein a mode of pore diameters of the pores is in a range of from 0.8 μm to 1.6 μm. Further, the flame retardant can be a cyclic phosphazene compound having a solid body under a room temperature. The conductor may include a carbon material. The positive electrode active material may include a lithium manganese complex oxide having a spinel crystal structure. At this time, an average diameter of secondary particles of the positive electrode active material can be 20 μm or more.

### Effects of the Invention

According to the present invention, effects can be obtained that, since the flame retardant is dispersed and mixed to the positive electrode mixture layer, the flame retardant can restrict burning of a battery constituting material when a battery temperature increases due to battery abnormality, and since the conductor dispersed and mixed to the positive electrode mixture layer is set to that a ratio of a mass of the conductor to that of the flame retardant is 1.3 or more, lowering of a discharge capacity to a design capacity of 5 Ah or more can be controlled even at the time of high rate discharging because electron conductivity due to charging/discharging can be secured even if the low- or non-conductive fame retardant is dispersed and mixed to the positive electrode mixture layer.

### BRIEF DESCRIPTION OF THE DRAWINGS

FIG. 1 is a perspective view of a lithium-ion secondary battery of an embodiment in which a laminate film is used for an outer casing and to which the present invention is applicable;

FIG. 2 is a sectional view showing an electrode group of the lithium-ion secondary battery in the embodiment;

FIG. 3 is a graph showing a relationship between a mass ratio of a conductor to a solid flame retardant both mixed to a positive electrode mixture and a ratio of a discharge capacity discharged at 5.0 C to that discharged at 0.2 C in a lithium-ion secondary battery of Example 1;

FIG. 4 is a graph showing a relationship between a mass ratio of a conductor to a solid flame retardant mixed to a positive electrode mixture and a ratio of a discharge capacity discharged at 5.0 C to that discharged at 0.2 C in a lithium-ion secondary battery of Example 2;

FIG. 5 is a graph showing a relationship between a mass ratio of a conductor to a solid flame retardant mixed to a positive electrode mixture and a ratio of a discharge capacity discharged at 5.0 C to that discharged at 0.2 C in a lithium-ion secondary battery of Example 3;

FIG. 6 is a graph showing a relationship between a mode of pore diameters at a positive electrode mixture and a ratio of a discharge capacity discharged at 5.0 C to that discharged at 0.2 C in a lithium-ion secondary battery of Example 4; and

FIG. 7 is a graph showing a relationship between a design capacity of a lithium-ion secondary battery and a maximum end-point temperature in a nailing test.

### DETAILED DESCRIPTION OF THE PREFERRED EMBODIMENTS

With reference to the drawings, an embodiment in which the present invention is applied to a lithium-ion secondary battery will be explained below.

(Constitution)

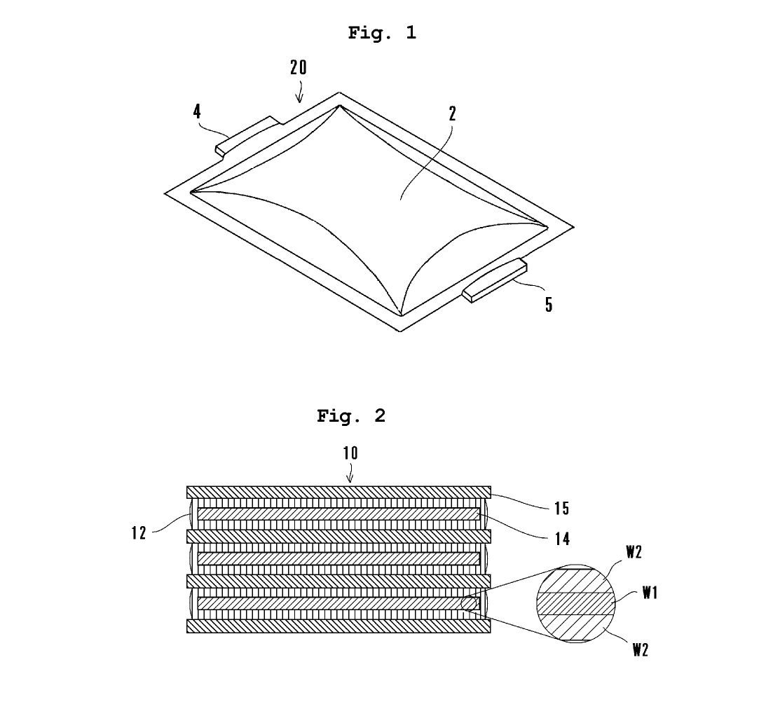

As shown in FIG. 1, in a lithium-ion secondary battery (non-aqueous secondary battery) 20 of this embodiment, a rectangular laminate film 2 having four sides is used as an outer casing. A laminated electrode group is sealed within the laminate film 2. When the lithium-ion secondary battery 20 is placed on a plate, the laminate film 2 located at an upper side of the laminated electrode group is shaped convex, and the laminate film 2 located at a lower side is shaped flat approximately, respectively. The four sides fringing the laminate film 2 are sealed by heat welding to secure a sealing structure for the lithium-ion secondary battery 20. A positive electrode terminal 4 and a negative electrode terminal 5 are sandwiched by heat welding portions of the laminate film 2 to respectively protrude their distal end portions toward an exterior opposed to each other at opposing two sides fringing the laminate film 2.

An aluminum foil having a thickness of 40 μm is used for the laminate film 2 as its base material. The aluminum foil is laminated by a nylon-made film having a thickness of 25 μm for insulation protection at one face, and a polypropylene-made film of heat welding resin having a thickness of 80 μm at another face. The nylon-made film, the aluminum foil and the polypropylene-made film are laminated in this order via adhesives and pressed to form the laminate film 2 having a three layered structure.

An aluminum plate is used for the positive electrode terminal 4, and a polypropylene-made tape having a thickness of 100 μm and a width of 10 mm is adhered to a circumference of the aluminum plate as a seal tape. A nickel plate is used for the negative electrode terminal 5, and a polypropylene-made tape having a thickness of 100 μm and a width of 10 mm is adhered to a circumference of the nickel plate as a seal tape. The polypropylene resin of the laminate film 2 softened at the time of heat welding sticks without a gap to the surroundings of the positive electrode terminal 4 and the negative electrode terminal 5.

As shown in FIG. 2, a laminated electrode group 10 to be sealed within the laminate film 2 is formed by laminating 10 pieces of positive electrode plate 14 and 11 pieces of negative electrode plate 15 alternatively so that the negative electrode plate 15 is located at vertical both ends of the laminated electrode group 10. Each positive electrode plate 14 is inserted into a separator 12 in which three sides of a rectangular polyethylene-made film having a thickness of 40 μm are heat-welded to form a sack. Thus, the separator 12 lies between each positive electrode plate 14 and each negative electrode plate 15. The positive and negative electrodes are laminated so that unillustrated positive electrode leads are located at one of the opposite two sides of the laminated electrode group 10 and negative electrode leads are located at another of the opposite two sides. Each of the positive electrode leads and the negative electrode leads are gathered to be welded by ultrasonic welding to the positive electrode terminal 4 and the negative electrode terminal 15, respectively.

The positive electrode plate 14 constituting the laminated electrode group 10 has an aluminum foil W1 as a positive electrode collector. The thickness of the aluminum foil W1 is set to 20 μm in this embodiment. A positive electrode mixture layer W2 is formed by applying a positive electrode mixture containing a lithium manganese complex oxide as a positive electrode active material to both surfaces of the aluminum foil W1 Lithium manganate powder having a spinel crystal structure is used for the lithium manganese complex oxide in this embodiment. In the positive electrode mixture layer W2, other than the positive electrode active material, a carbon material as a conductor, polyvinylidene fluoride (hereinafter abbreviated as PVDF) as a binder and a powder-state (solid body) phosphazene compound as a flame retardant are dispersed and mixed so as to be uniformly. Graphite power and acetylene black powder are used for the conductor in this embodiment.

Here, particle diameters of the positive electrode active material and the conductor will be explained. The lithium manganate power which is the positive electrode active material in this embodiment forms secondary particles in which primary particles are coagulated. The lithium manganate having an average secondary particle diameter of 20 μm or more may be used as lithium manganate, however in this embodiment, the lithium manganate having an average secondary particle diameter of 25 μm is used as lithium manganate in this embodiment. Particles of which average secondary particle diameter is 20 μm or more can be obtained, for example, by classification, and which have a large particle size comparing with the lithium manganate used conventionally. In the lithium manganate having an average secondary particle diameter of 20 μm or more, a surface area of the particle to a volume thereof becomes small comparing with the lithium manganate having an average secondary particle diameter of less than 20 μm, and thereby low electrical resistance may be realized even if the amount of the conductor is small. Like this embodiment, in a case that the flame retardant having an insulation property is mixed to the positive electrode mixture, it is advantageous in making up for conductivity.

The amount of the positive electrode active material dispersed and mixed to the positive electrode mixture layer W2 is adjusted by a design capacity of the lithium-ion secondary battery 20 to be obtained. For example, as shown in Table 1 below, in a case of the design capacity of 10 Ah, the positive electrode active material of 130 g can be dispersed and mixed. The amount of the phosphazene compound of a flame retardant is adjusted from 2.5 to 7.5 mass % (wt %) to the mass of the positive electrode active material. The amount of the carbon material of a conductor (total of graphite and acetylene black) is adjusted to 1.3 times or more to the mass of the phosphazene compound. In short, a ratio of a mass of the conductor is 1.3 times or more to that of the flame retardant. Incidentally, in Table 1, in a case that the above-stated lithium manganate is used as the positive electrode active material, the values, when the amount of the flame retardant is set to 5 wt % to the mass of the positive electrode active material and the amount of the conductor is set to 1.5 times to that of the flame retardant, are shown together with design capacities.

TABLE 1

| | | | Amount of Flame | |
|---|---|---|---|---|
| | Active | | Retardant (g) | Amount of |
| Capacity | Material | Electrolyte | 5% to Active | Conductor |
| (Ah) | (g) | (g) | Material | (g) |
| 1 | 12 | 10 | 0.65 | 1.0 |
| 5 | 65 | 50 | 3.25 | 4.9 |
| 10 | 130 | 100 | 6.5 | 9.8 |
| 20 | 260 | 200 | 13 | 19.5 |
| 50 | 650 | 500 | 32.5 | 48.8 |
| 100 | 1300 | 1000 | 65 | 97.5 |

When the positive electrode mixture is applied to the aluminum foil W1, a slurry that the positive electrode mixture is viscosity-controlled by N-methyl-2-pyrolidone (hereinafter abbreviated as NMP) of a dispersion solvent is produced. The flame retardant is dispersed to the slurry approximately uniformly and is applied to the aluminum foil W1 so as to be integrated with the positive electrode mixture layer W2. The positive electrode plate 14, after applying the positive electrode mixture, is dried, pressed and cut to form a rectangular shape. Incidentally, a strip-shaped positive electrode lead piece made of aluminum is welded by ultrasonic welding to one side of the positive electrode collector.

The phosphazene compound is a cyclic compound expressed by a general formula of (NPR₂)₃ or (NPR₂)₄. R in the general formula expresses halogen such as fluorine, chlorine or the like, or univalent substituent. As the univalent substituent, alkoxy group such as methoxy group, ethoxy group and the like, aryloxyl group such as phenoxy group, methylphenoxy group and the like, alkyl group such as methyl group, ethyl group and the like, aryl group such as phenyl group, tolyl group and the like, amino group including substitutional amino group such as methylamino group and the like, alkylthio group such as methylthio group, ethylthio group and the like, and arylthio group such as phenylthio group may be listed.

In the manufactured positive electrode plate 14, pores (gaps of compound particles contained in the positive electrode mixture) are formed at the positive electrode mixture layer W2. The size of the pore diameter can be adjusted by a load loaded at the time of pressing or a gap between press rollers. The pore diameter, for example, can be measured by a mercury porosimetry which measures a pore distribution in a porous solid body according to a mercury penetration method. In this embodiment, a mode of pore diameters is adjusted in a range of from 0.8 to 1.6 μm.

On the other hand, the negative electrode plate 15 has a rolled copper foil as a negative electrode collector. The thickness of the rolled copper foil is set to 10 μm in this embodiment. A negative electrode mixture layer is formed by applying a negative electrode mixture containing a carbon material such as amorphous carbon powder, graphite powder or the like, by which lithium-ions can be occluded/released as a negative electrode active material, to both surfaces of the rolled copper foil. For example, to 90 mass part of the carbon material, 10 mass part of PVDF as a binder is mixed in the negative electrode mixture. When the negative electrode mixture is applied to the rolled copper foil, a slurry that the negative electrode mixture is viscosity-controlled by NMP of a dispersion solvent is produced. The negative electrode plate 15, after applying the negative electrode mixture, is dried, pressed and cut to form a rectangular shape. Incidentally, a strip-shaped negative electrode lead piece made of copper is welded by ultrasonic welding to one side of the negative electrode collector.

(Assembling of Battery)

The lithium-ion secondary battery 20 is completed to assemble in the following order. Namely, to a pedestal made of silicone rubber at which a concave portion is formed to fit the shape of the laminated electrode group 10, the laminate film 2 and the laminated electrode group 10 are placed in this order to fit the concave portion of the pedestal. After a non-aqueous electrolyte is injected into the laminate film 2 forming a concave portion, the laminate film 2 forming the concave portion is covered by another piece of the laminate film 2 to lay the periphery portions of the two pieces of the laminate film 2 each other. At this time, the distal end portions of the positive electrode terminal 4 and the negative electrode terminal 5 are located to respectively protrude their distal end portions toward an exterior opposed to each other at opposing two sides fringing the laminate film 2. The fringing portions of the laminate film 2 are heat welded under a reduced pressure atmosphere by pressing a metal plate heated at a melting temperature against the upper side of the laminate film covering the laminated electrode group 10. Lithium hexafluorophosphate (LiPF₆) as a lithium salt (electrolyte), dissolved at 1 mol/l (1M) into a mixed solvent of ethylene carbonate and dimethyl carbonate at a volume ratio of 1:1, is used for the non-aqueous electrolyte in this embodiment.

### EXAMPLES

Examples of the lithium-ion secondary battery 20 manufactured according to this embodiment will be explained below. Incidentally, lithium-ion secondary batteries of comparative examples manufactured for comparison will also be explained.

### Example 1

In Example 1, the amount of the phosphazene compound mixed to the positive electrode mixture was set at 2.5 wt % to the positive electrode active material, and two kinds of graphite powder (manufactured by Nippon Graphite Industries, Co., Ltd., Product Name: JSP, Particle Diameter: about 3 μm) and acetylene black (manufactured by Denki Kagaku Kogyo Kabushiki Kaisha, Product Name: HS, Particle Diameter: 48 nm) were used as a conductor. The design capacity of the battery was set to 10 Ah by adjusting the number of laminating plates in the electrode group so that the total amount of the positive electrode active material is set to 130 g. (See Table 1, too.) Five kinds of lithium-ion secondary battery 20 were manufactured by changing the amount of the conductor to that of the phosphazene compound. The mass ratio of conductor/phosphazene compound was set to 1.0, 1.1, 1.3, 1.5 and 1.7, respectively.

With respect to the five kinds of lithium-ion secondary battery 20, a high rate discharge property was evaluated. Namely, after an initial charge was carried out to each lithium-ion secondary battery, a discharge capacity was measured by changing to discharge rates of 0.2 C and 5 C. (A discharge rate nC expresses a current value when a total capacity is discharged at 1/n hours.) The current value at each discharge rate is 2 A and 50 A, respectively. A ratio of a discharge capacity discharged at 5 C to that discharged at 0.2 C was calculated to establish a standard for a high rate discharge property.

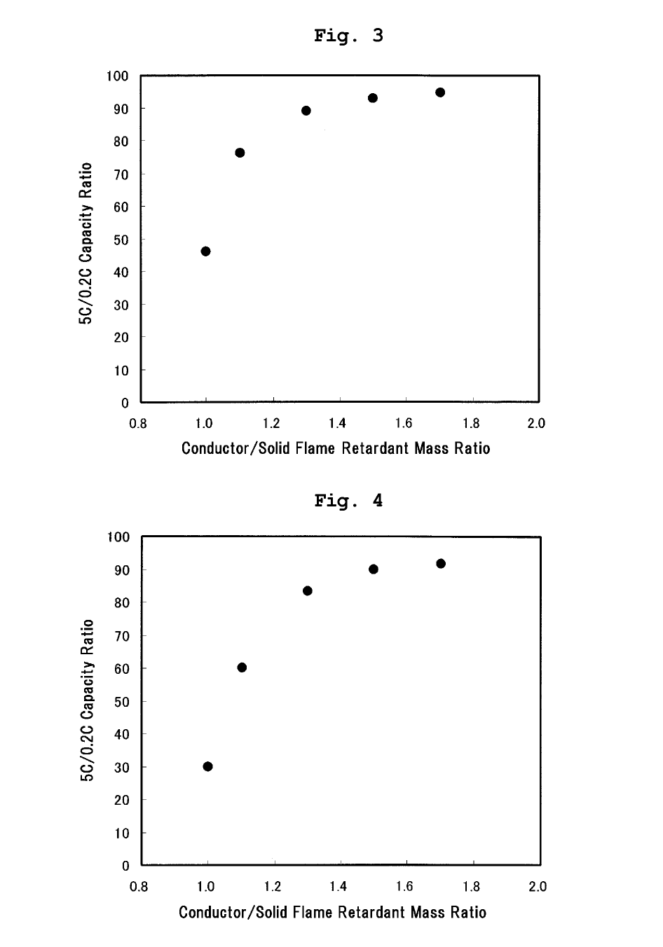

As shown in FIG. 3, it was found that, with an increase in the mass ratio of conductor/solid (body) flame retardant, a high rate discharge property, namely a 5 C/0.2 C capacity ratio increases. It was also made clear that, by setting a conductor/solid flame retardant mass ratio to a range of from 1.3 to 1.7, a high rate discharge property of which capacity ratio is approximately 90% or more can be obtained. In other words, because the amount of the phosphazene compound was set at 2.5 wt % to the positive electrode active material, a preferable high rate discharge property can be obtained if the conductor is mixed in a range of from 3.25 to 4.25 wt %.

### Example 2

In Example 2, five kinds of lithium-ion secondary battery 20 were manufactured in the same manner as Example 1 except that the amount of the phosphazene compound mixed to the positive electrode mixture was set at 5 wt % to the positive electrode active material.

With respect to the five kinds of lithium-ion secondary battery 20, a high rate discharge property was evaluated in the same manner as the evaluation in Example 1. As shown in FIG. 4, it was found that, with an increase in the mass ratio of conductor/solid flame retardant, a high rate discharge capacity, namely a 5 C/0.2 C capacity ratio increases. It was also made clear that, by setting a conductor/solid flame retardant mass ratio to a range of from 1.3 to 1.7, a high rate discharge property of which capacity ratio is 80% or more can be obtained. In other words, because the amount of the phosphazene compound was set at 5 wt % to the positive electrode active material, a preferable high rate discharge property can be obtained if the conductor is mixed in a range of from 6.5 to 8.5 wt %.

### Example 3

In Example 2, five kinds of lithium-ion secondary battery 20 were manufactured in the same manner as Example 1 except that the amount of the phosphazene compound mixed to the positive electrode mixture was set at 7.5 wt % to the positive electrode active material.

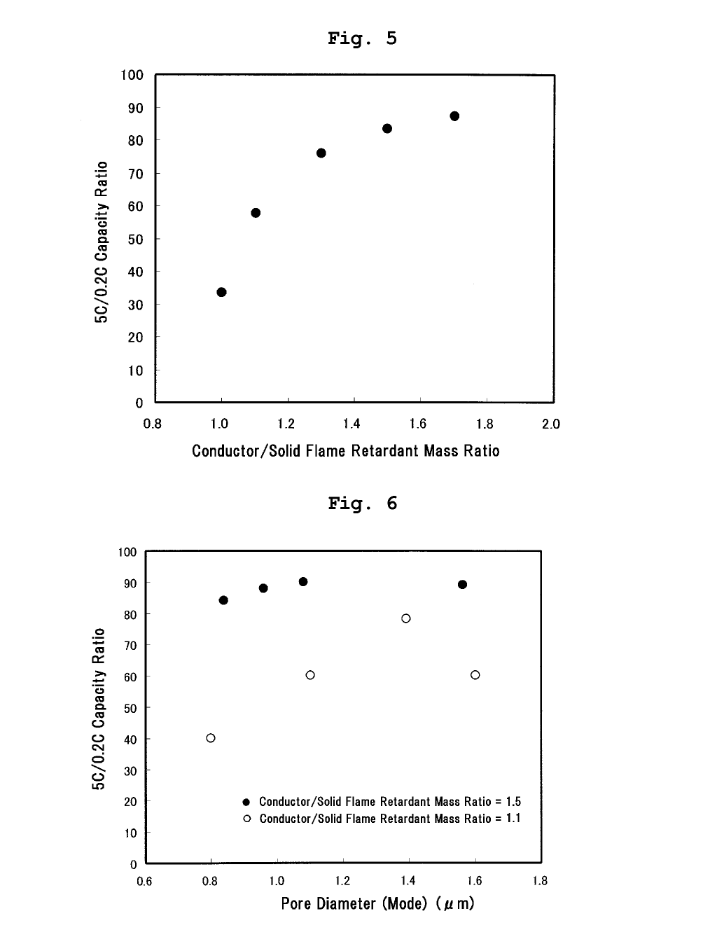

With respect to the five kinds of lithium-ion secondary battery 20, a high rate discharge property was evaluated in the same manner as the evaluation in Example 1. As shown in FIG. 5, it was found that, with an increase in the mass ratio of conductor/solid flame retardant, a high rate discharge capacity, namely a 5 C/0.2 C capacity ratio increases. It was also made clear that, by setting a conductor/solid flame retardant mass ratio to a range of from 1.3 to 1.7, a high rate discharge property of which capacity ratio is approximately 80% or more can be obtained. In other words, because the amount of the phosphazene compound was set at 7.5 wt % to the positive electrode active material, a preferable high rate discharge property can be obtained if the conductor is mixed in a range of from 9.75 to 12.75 wt %.

### Example 4

In Example 4, a high rate discharge property when the mode of pore diameters at the positive electrode mixture layer W2 is changed was evaluated. The amount of the phosphazene compound mixed to the positive electrode mixture was set at 5 wt % to the positive electrode active material. In a case that the mass ratio of conductor/phosphazene compound is adjusted at 1.5, namely adjusted at 1.3 or more as shown in this embodiment, the positive electrode plate 14 was made by changing a press pressure so that the mode of pore diameters is 0.9, 1.0, 1.1, and 1.6 μm, respectively to manufacture the lithium-ion secondary battery 20. The mode of pore diameters was measured by using a mercury porosimetry (made by Shimadzu Corporation, Autopore IV9520).

With respect to the obtained each lithium-ion secondary battery 20, a ratio of a discharge capacity discharged at 5 C to that discharged at 0.2 C was calculated in the same manner as the evaluation in Example 1. As shown in FIG. 6, in a case that the amount of the conductor is smaller than that of the flame retardant (white circles in the figure), a range of the pore diameters expressing that a capacity ratio is 60% or more fell within a range of from 1.1 to 1.6 μm. In contrast, in a case that the amount of the conductor was set to the range in this embodiment (black circles in the figure), the capacity ratio became large, and accordingly an improvement in a high rate discharge property was observed. Further, a range of the pore diameters expressing that a capacity ratio is 80% or more fell within a range of from 0.9 to 1.6 μm, and accordingly it was made clear that an excellent high rate discharge property is exhibited in a broad range of pore diameters.

Based upon the results in Example 4, when attention is paid to the mode of pore diameters at the positive electrode mixture layer W2, the following can be considered with respect to a relationship between safety and a high rate discharge property in the lithium-ion secondary battery 20. Namely, in order to enhance electron conductivity at the electrode, there is a way for increasing conductive paths by setting the pore diameters at the mixture layer small to improve a contacting property between the active material and the conductor. However, in a case that the pore diameters are set small, it is not only disadvantageous in the movement of lithium-ions but it is also necessary to improve precision in applying and pressing at the time of manufacturing the electrode in order to control the pore diameters precisely. But, it is difficult in manufacture to control the applying and pressing uniformly at an entire portion of the electrode having a large area. While, the pores may become large resiliently with a lapse of time even after the electrode is made. Further, the pore diameters may change due to swelling in the electrolyte and due to swelling/shrinking according to charging/discharging. For the reasons, the movement in lithium-ions and electrons is affected by the difference in the pore diameters, and accordingly it is difficult to obtain a stable battery property. By contrast, in the lithium-ion secondary battery 20 of Example 4 manufactured according to this embodiment could obtain an excellent property with the pore diameters in a relatively broad range as stated above. Accordingly, it was made clear that a large capacity battery excellent in safety and a high rate discharge property can be provided stably.

(Effects and the Like)

Next, effects and the like of the lithium-ion secondary battery 20 in this embodiment will be explained.

First, with respect to the effects on safety due to that the flame retardant is dispersed and mixed to the positive electrode mixture layer W2, the results evaluated by a relationship between a design capacity of the battery and a battery surface maximum end-point temperature at a nailing test will be explained. In this evaluation, with respect to each of a case that the solid flame retardant is not mixed to the positive electrode mixture and a case that the solid flame retardant is mixed to the positive electrode mixture at 5 wt % to the positive electrode active material, a lithium-ion secondary battery respectively having a design capacity of 1, 10, 20, 50 and 100 Ah was manufactured in the same manner as this embodiment except that the laminated electrode group is accommodated in a battery container made of stainless steel. (See Table 1, too.) Each manufactured lithium-ion secondary battery was placed horizontally on a flat bed, and then a nailing test that a ceramic nail having a diameter of 5 mmφ is thrust from an upper side of the battery to a center portion of the battery at a nailing speed of 1.6 mm/s was carried out to observe the states of releasing of fume, bursting and catching fire and to measure a temperature at a battery surface.

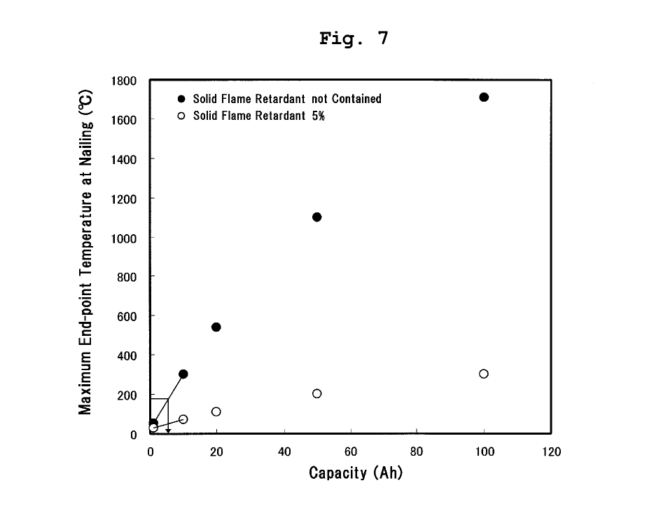

As shown in FIG. 7, regarding a lithium-ion secondary batter to which no solid flame retardant is mixed (shown in FIG. 7 by black circles), in the battery of which design capacity is 1 Ah or so, the maximum end-point temperature was ranged from 30 deg. C to 50 deg. C. at the nailing test. Further, when the design capacity is up to 5 Ah or so, the maximum end-point temperature could be controlled less than 180 deg. C., and thereby thermal runaway could be avoided. However, when the design capacity exceeds 5 Ah, the maximum end-point temperature went up over 180 deg. C. at the nailing test, the thermal runaway accompanied by releasing of fume was brought about. This reason is considered that, with the large sizing of the lithium-ion secondary battery, as a result that a ratio of a surface area to a unit volume becomes small and heat release could not catch up with heat generation due to the nailing test, heat was stored within the lithium-ion secondary battery. Furthermore, when the design capacity exceeds 20 Ah, the maximum end-point temperature reached several hundred deg. C., and not only releasing of fume but also catching fire as well as bursting of the battery container were observed. When the design capacity is 100 Ah, the maximum end-point temperature reached 1700 deg. C. or more and the battery fell into a very dangerous situation.

By contrast, regarding a lithium-ion secondary batter to which the solid flame retardant of 5 wt % is mixed (shown in FIG. 7 by white circles), the maximum end-point temperature was controlled at 400 deg. C. or less even if the design capacity is 100 Ah. The lithium-ion secondary battery of which design capacity is 100 Ah fell into thermal runaway, however, catching fire or bursting was not observed while merely releasing of fume was observed. Further, it was made clear that thermal runaway is not brought about if the design capacity is up to approximately 50 Ah. Accordingly, it was made obvious that the behavior at the time of battery abnormality becomes calm by mixing the solid flame retardant to the positive electrode mixture.

In this embodiment, the phosphazene compound of a flame retardant is dispersed and mixed uniformly to the positive electrode mixture layer W2. This phosphazene compound is considered to function so as to stop a chain reaction by reacting with the active species generated at the time of burning of electrolyte. For this reason, since burning of a battery constituting material is controlled, safety of the lithium-ion secondary battery 20 can be secured.

Further, in this embodiment, the conductor of which mass ratio is set to 1.3 or more to the mass of the flame retardant is dispersed and mixed uniformly to the positive electrode mixture layer W2. Because the phosphazene compound dispersed and mixed to the positive electrode mixture layer W2 has a property of low conductivity or non-conductivity, conductivity at the positive electrode mixture layer W2 may be lowered, and thereby the discharge capacity at the time of high rate discharging may be deteriorated. However, electron conductivity due to charging/discharging is secured because, together with the flame retardant, the conductor of which mass ratio is set to 1.3 or more to the mass of the flame retardant is mixed to the positive electrode mixture layer W2. Thus, lowering of a discharge capacity can be restricted at the time of high rate discharging. If the mass ratio of the conductor to the flame retardant is less than 1.3, conductivity becomes insufficient and it is difficult to secure the discharge capacity sufficiently at the time of high rate discharging. To the contrary, if the mass ratio exceeds 1.7, a degree of improving the high rate discharge property becomes small. Further, when it is considered that the battery size is the same, the battery capacity drops, because larger the amount of the conductor becomes, smaller that of the positive electrode active material becomes.

Additionally, with respect to the mixing amount of the conductor, a case that the mass ratio of the conductor to the mass of the flame retardant is ranged from 1.0 to 1.7 was shown, however, even if the mass ratio exceeds 1.7, the safety and the high rate discharge property can be secured in a well-balanced manner. In other words, the battery capacity becomes lowered if the mixing amount of the conductor increases, however, this may be adjusted by the design specification such as battery capacity, energy density, high rate discharge property and the like adapted to the use and user needs of the product. Further, in a case that the conductor is too much, because there is a possibility to cause such a problem that kneading in a uniform dispersing state may become difficult when the slurry of the positive electrode mixture is produced, it is important to consider a viewpoint in manufacture.

Furthermore, in this embodiment, the amount of the flame retardant dispersed and mixed to the positive electrode mixture layer W2 is adjusted in a range of 2.5 to 7.5 wt % to the positive electrode active material. When the design capacity of the lithium-ion secondary battery is large, because the amount of the positive electrode active material and the electrolyte is increased (See Table 1, too.), heat release at the time of battery abnormality becomes large. While, when the design capacity is made large, because the surface area of the battery does not become large comparing with an increase in the volume, the battery hardly releases heat and stores heat. For this reason, if the amount of the flame retardant is less than 2.5 wt %, it is difficult for the lithium-ion secondary battery having a design capacity exceeding 5 Ah to obtain sufficient fire resistance performance. To the contrary, if the amount of the flame retardant exceeds 7.5 wt %, because the amount of the positive electrode active material is limited relatively due to that the amount of the flame retardant becomes large when a case that the battery size is the same is considered, the capacity becomes lowered.

Moreover, in this embodiment, the mode of pore diameters formed at the positive electrode mixture layer W2 is adjusted in a range of from 0.8 to 1.6 μm. For this reason, the electron conductivity in the positive electrode and the movement of lithium-ions at the time of charging/discharging are secured. Accordingly, even at the time of the high rate discharging, the high rate discharge property that the ratio of the discharge capacity discharged at 5 C to that discharged at 0.2 C is 80% or more can be demonstrated. (See Example 4.)

As stated above, the lithium-ion secondary battery 20 in this embodiment can secure safety at the time of battery abnormality and control lowering in the discharge capacity at the time of high rate discharging. Such a lithium-ion secondary battery can exhibit function in a battery having a design capacity of 5 Ah or more. Further, this technical idea can be utilized to a battery that is required to have the capacity of from dozens of Ah to 100 Ah or more and that is used as the power source for operating industrial equipment, for storing the power generated by a generating apparatus due to sunshine, wind force or the like.

Incidentally, in this embodiment, the phosphazene compound in which phosphorus and nitrogen are used as a base skeleton were exemplified as a flame retardant, however, the present invention is not limited to this. A phosphazene compound that gives flame resistance or self-extinction may be also used. Further, with respect to the phosphazene compound, the compound other than that shown in this embodiment can be used. An example that graphite and acetylene black are used as a conductor was shown as a conductor, the present invention is not limited to this. A carbon material may be used as a conductor, and one kind thereof may be used, or two kinds thereof or more may be used in a mixing manner.

Further, in this embodiment, the lithium manganate having a spinel crystal structure was shown as a positive electrode active material, the present invention is not confined to this. As a positive electrode active material, a lithium manganese complex oxide may be used and any lithium manganese complex oxide used for a lithium-ion secondary battery in general can also be used. Further, a material that a part of lithium or manganese is replaced or doped by other element can be also used. Further, in this embodiment, a carbon material such as amorphous carbon powder, graphite powder or the like was exemplified as a negative electrode active material, however, the present invention is not limited to this, and a shape thereof is not especially limited to sphere, scale, fiber, massive or the like.

Furthermore, in this embodiment, the lithium-ion secondary battery 20 in which the laminate film is used as an outer casing was exemplified, however, the present invention is not limited to this. For example, in place of the laminate film, the electrode group may be accommodated into a cylindrical or square battery container. Further, in this embodiment, the electrode group 10 stacked by the positive electrode plate 4 and the negative electrode plate 5 was exemplified, however, the present invention is not restricted to this. For example, an electrode group wound by a strip-shaped positive electrode plate and a strip-shaped negative electrode plate may be used. Furthermore, the present invention is also applicable to a non-aqueous electrolyte secondary battery using a non-aqueous electrolyte other than the lithium-ion secondary battery. It goes without saying that the composition of the electrolyte is not especially limited.

### INDUSTRIAL APPLICABILITY

Because the present invention provides a non-aqueous electrolyte battery capable of improving a high rate discharge capacity while securing safety thereof, the present invention contributes to manufacturing and marketing of a non-aqueous electrolyte battery. Accordingly, the present invention has industrial applicability.

1. A non-aqueous electrolyte secondary battery of which design capacity is 5 Ah or more, comprising:
a positive electrode plate having a positive electrode mixture layer; and
a negative electrode plate having a negative electrode mixture layer in which a negative electrode active material is included,
wherein the positive electrode mixture layer includes a positive electrode active material, a flame retardant, a conductor and a binder, and is formed in a manner that these are dispersed and mixed,
wherein a ratio of a mass of the conductor to that of the flame retardant is 1.3 or more, and wherein the flame retardant is a cyclic phosphazene compound having a solid body under a room temperature.

2. The non-aqueous electrolyte secondary battery according to claim 1, wherein the positive electrode mixture layer is formed in a manner that the flame retardant is dispersed and mixed in a range of from 2.5 mass % to 7.5 mass % to the positive electrode active material.

3. The non-aqueous electrolyte secondary battery according to claim 2, wherein pores are formed at the positive electrode mixture layer, and wherein a mode of pore diameters of the pores is in a range of from 0.8 μm to 1.6 μm.

4. (canceled)

5. The non-aqueous electrolyte secondary battery according to claim 1, wherein the conductor includes a carbon material.

6. The non-aqueous electrolyte secondary battery according to claim 1, wherein the positive electrode active material includes a lithium manganese complex oxide having a spinel crystal structure.

7. The non-aqueous electrolyte secondary battery according to claim 6, wherein an average diameter of secondary particles of the positive electrode active material is 20 μm or more.
